(19) United States
(12) Patent Application Publication
(10) Pub. No.: US 2005/0012633 A1
(43) Pub. Date: Jan. 20, 2005

(54) Emergency lighting fixture in switch cover

(76) Inventor: Heung-Sik Yoon, Seoul (KR)

Correspondence Address: Robert E. Bushnell, Suite 300, 1522 K Street, N.W., Washington, DC, 20005, US

(21) Appl. No.: 10/887,825

(22) Filed: Jul. 12, 2004

(30) Foreign Application Priority Data
Jul. 11, 2003 (KR) 2003-47326

(51) Int. Cl. G08B 23/00

(52) U.S. Cl. 340/693.5; 340/815.4

(57) ABSTRACT

An emergency lighting fixture mounted under a switch cover that protects an electrical switch button for turning on/off the indoor lights, with a lamp concealed inside the cover providing lighting to an indoor area during normal times as well as in emergency situations involving power failures caused by shutoff of electricity, fire, or natural disasters like earthquakes. A transparent window on the same surface adjacent to lamp transmits light from the lamp. A switch on the front surface of the cover turns the lamp on or off, and a control circuit is mounted inside the cover, with a charging unit, a power-failure sensing unit, an emergency sensing unit, and a control unit.

### CLAIM OF PRIORITY

This application makes reference to, incorporates the same herein, and claims all benefits accruing under 35 U.S.C. § 119 from an application entitled EMERGENCY LIGHTING FIXTURE IN SWITCH COVER earlier filed in the Korean Intellectual Property Office on 11 Jul. 2003 and thereby duly assigned Serial No. 2003-47326.

### BACKGROUND OF THE INVENTION

1. Field of the Invention

The present invention relates to an emergency lighting fixtures generally, and, more particularly, to lighting fixtures mounted under switch covers that protect an indoor light switch button for turning indoor lights on and off, in which a lamp concealed inside the switch cover provides lighting to an indoor area during normal times as well as in emergency situations involving power failures caused by shutoff of electricity, fire, or natural disasters like earthquakes.

2. Description of the Related Art

In general, a switch cover encompasses and protects a wall-mounted switch button for turning ceiling lights on and off.

The switch cover is usually in the shape of a plate perforated by a square cutout accommodating the button for a switch. Traditionally the switch cover does not have its own source of illumination. Therefore, when an interior area is dark, people have had difficulty in locating the button. Also, during the nighttime, many home owners prefer illumination with a soft glow that provides only enough light to recognize things in a house rather than bright illumination source of which enables the occupants to see every thing clearly. Because switch covers did not have a source of illumination that provided a soft-glow effect, people simply purchased extra, expensive bed lights or installed supplementary lights for nighttime use.

Furthermore, contemporary switch covers have not provided an emergency lighting fixture that is able to illuminate the indoor area during power failures caused by electrical short circuits, fire, earthquakes, etc. When these emergency situations occur at night, resulting in unexpected power failures, most people feel insecure or anxious because they cannot see or recognize any of the objects or structural features around them. Problems get worse because it is not easy to find portable light sources, such as flashlights or candles, at night without the aid of light.

I have discovered that a need exists for a simple and easily installable emergency light source that includes a fixedly-attached housing which may easily be substituted for standard switch plates, and which activates itself to provide a source of illumination in response to a power failure of any kind.

### SUMMARY OF THE INVENTION

It is, therefore, an object of the present invention to provide an improved lighting fixture.

It is another object to provide an improved switch cover.

It is yet another object to provide an emergency lighting fixture in a switch cover for providing lighting to an indoor area during emergency situations involving power failures caused by an interruption of electrical service, fire, or natural disasters like earthquakes, whereby people do not become excessively anxious or feel insecure when hearing emergency alarms, but are enable to react to those emergency situations more bravely, and are able to calmly look for portable light sources like flashlights or candles.

It is still another object to provide an emergency lighting fixture in a switch cover as a replacement for a bed light or a supplementary light at night, while enabling the occupant to locate switch buttons for turning on the indoor lights.

To achieve these and other objects, there is provided an emergency lighting fixture in a switch cover, constructed with at least one of the switch buttons located on a front surface of a indoor light switch button for turning on and off the indoor lights including ceiling lights. At least one illumination lamp may be installed on an inside surface of the switch cover, with a transparent window installed on the same surface where the illumination lamp is installed, to transmit a light from the illumination lamp. An illumination lamp switch button may be positioned below the switch buttons to enable the user to turn on and off the illumination lamp and a control circuit-mounted substrate may be mounted inside the switch cover, The control circuit may be constructed with a unit that charges a supplementary power source by using AC power, a power-failure unit that senses power failures, an emergency sensing unit that detects the occurrence of emergencies like fire or earthquakes, and a control unit that generates an emergency alarm when charging is complete and when a sensing signal from each sensing unit is input, and generates a control signal when turning on the illumination lamp.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate same or similar components, wherein:

FIG. 1 is a perspective view of an emergency lighting fixture in a switch cover constructed according to the principles of the present invention as a first embodiment of the present invention;

FIG. 2 is a vertical cross-sectional elevational view of an emergency lighting fixture in a switch cover according to the first embodiment of the present invention;

FIG. 3 is a rear view of an emergency lighting fixture in a switch cover constructed according to the first embodiment of the present invention;

FIG. 4 is a schematic block diagram of a control circuit applied to an emergency lighting fixture in a switch cover constructed according to the first embodiment of the present invention;

FIG. 5 is a flow chart describing an operation of an emergency lighting fixture in a switch cover constructed according to the first embodiment of the present invention;

FIG. 6 is a vertical cross-sectional elevational view of an emergency lighting fixture in a switch cover constructed according to a second embodiment of the present invention; and

FIG. 7 is a partial assembly, cross-sectional elevational view of a third embodiment constructed according to the principles of the present invention.

### DETAILED DESCRIPTION OF THE INVENTION

Turning now to the drawings, the details of a first embodiment will be described by reference to the accompanying drawings. In the following description, well-known functions or constructions are not described in extensive detail since an exhaustive discussion would obscure the invention with unnecessary detail.

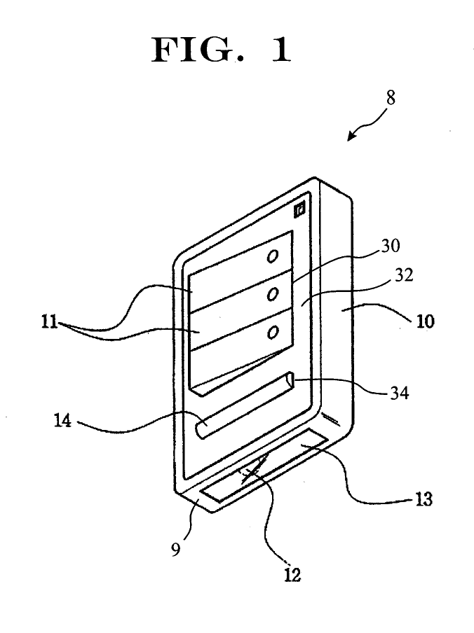

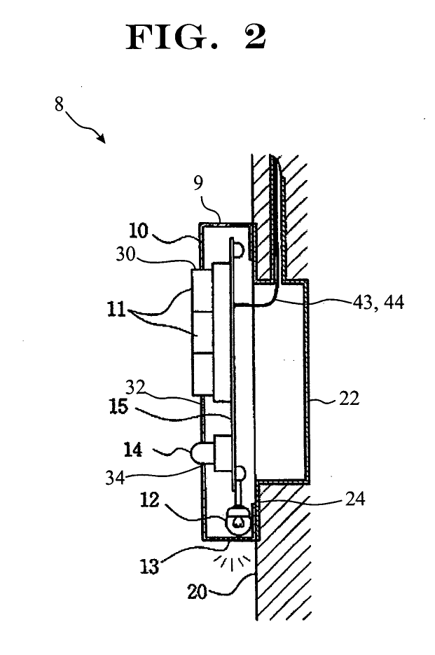

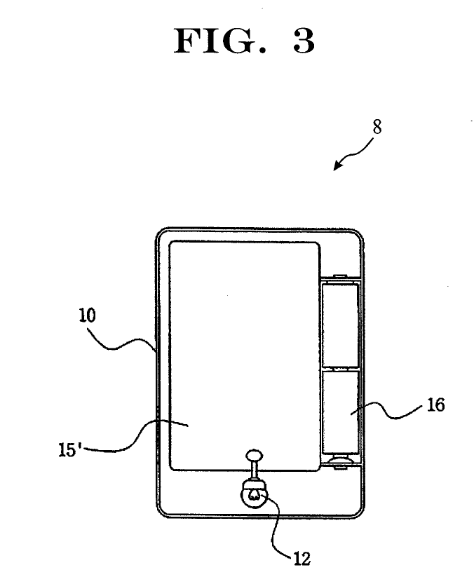

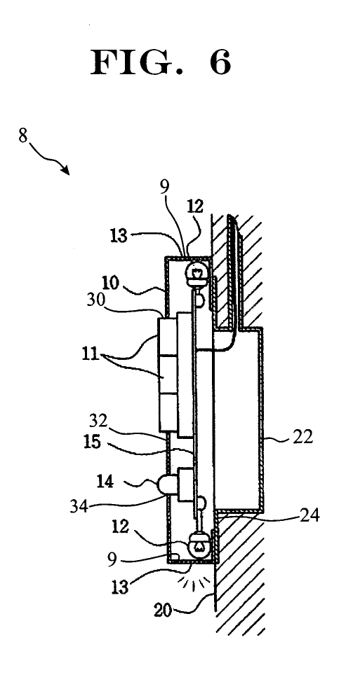

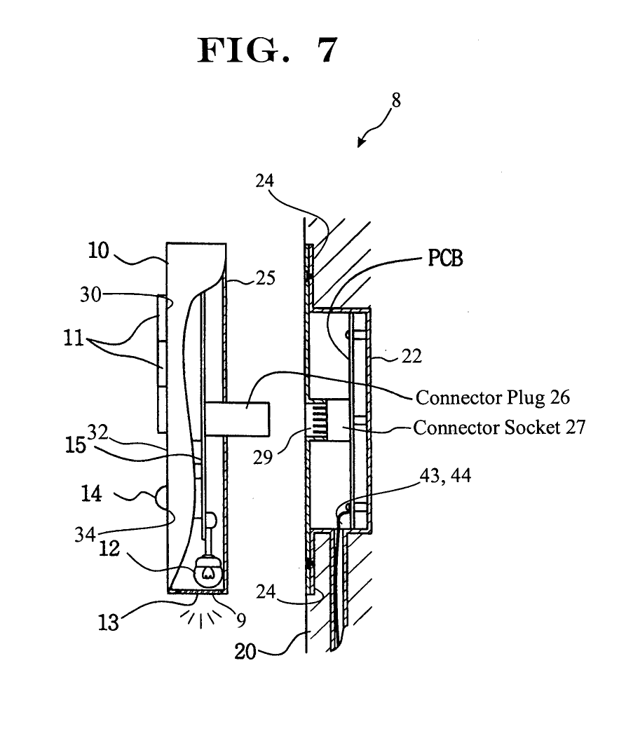

FIG. 1 is a perspective view of a switch cover 10 constructed according to a first embodiment of the present invention, and FIG. 2 and FIG. 3 respectively show a vertical cross-sectional view and a rear view of switch cover 10. FIG. 6 is a vertical cross-sectional view of switch cover 10 as constructed according to a second embodiment of the present invention, showing switch cover 10 mounted across flanges 24 and electrical box 22 that is recessed into the surface of a vertical wall 20 of an architectural structure, while FIG. 7 illustrates switch cover 10 fitted on its reverse side 25 with an electrical connector plug 26 bearing a plurality of electrical conductors (not shown), that is removably received by an electrical socket 27 surface mounted upon printed circuit board PCP 28 mounted within electrical box 22, to enable those electrical conductors to operationally mate with an array of corresponding electrical conductors 29 held by socket 27.

As shown in the drawings, switch cover 10 includes at least one, and possibly two or three, or more switch buttons 11 mounted within a aperture 30 that perforates the central front surface 32. Switch buttons 11 separately turn on and off indoor lights, such as ceiling lights, electrically wired into different, corresponding electrical circuits within the architectural structure such as a house or other dwelling. An illumination lamp 12 is mounted inside of switch cover 10, and a transparent window 13 is formed through side wall 9 on the same side of cover 10 where illumination lamp 12 is installed, in order to transmit light from illumination lamp 12. In essence, lamp 12 serves as an auxiliary source of illumination within the visible spectrum. An illumination lamp switch button 14 may be mounted within an aperture 34 in front surface 32 below the switch buttons 11 to permit a user to turn on and off illumination lamp 12. A circuit substrate 15 may be mounted with a control circuit and a re-chargeable battery 16 inside cover 10.

The first embodiment of the switch cover 10 illustrated in FIG. 1 through FIG. 3 collectively, has illumination lamp 12 located at the lower inside of side wall 9 of switch cover 10. Meanwhile, the second embodiment of switch cover 10 illustrated by FIG. 6 has two illumination lamps 12, with one lamp 12 positioned at the upper inside of switch cover 10 and the other lamp 12 positioned at the lower inside of switch cover 10, and with two correspondingly positioned transparent windows 13 enabling passage of light from lamps 12 to outside environment. One window 13 is located at the upper surface of side wall 9 of switch cover 10 and the other window 13 is located at the lower surface of side wall 9 of switch cover 10. The positions and the number of illumination lamps 12 and transparent window 13 can be modified or re-located to a different location within the practice of the principles of the present invention.

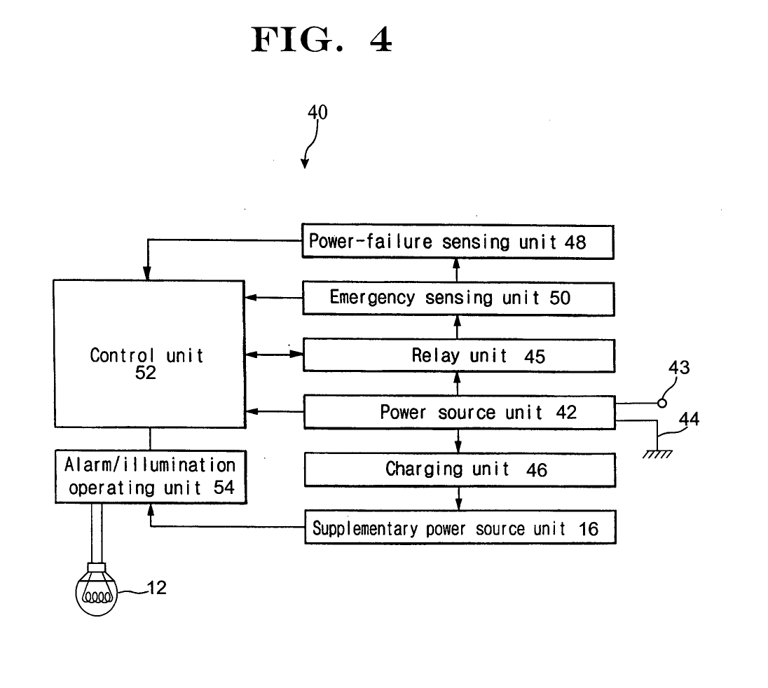

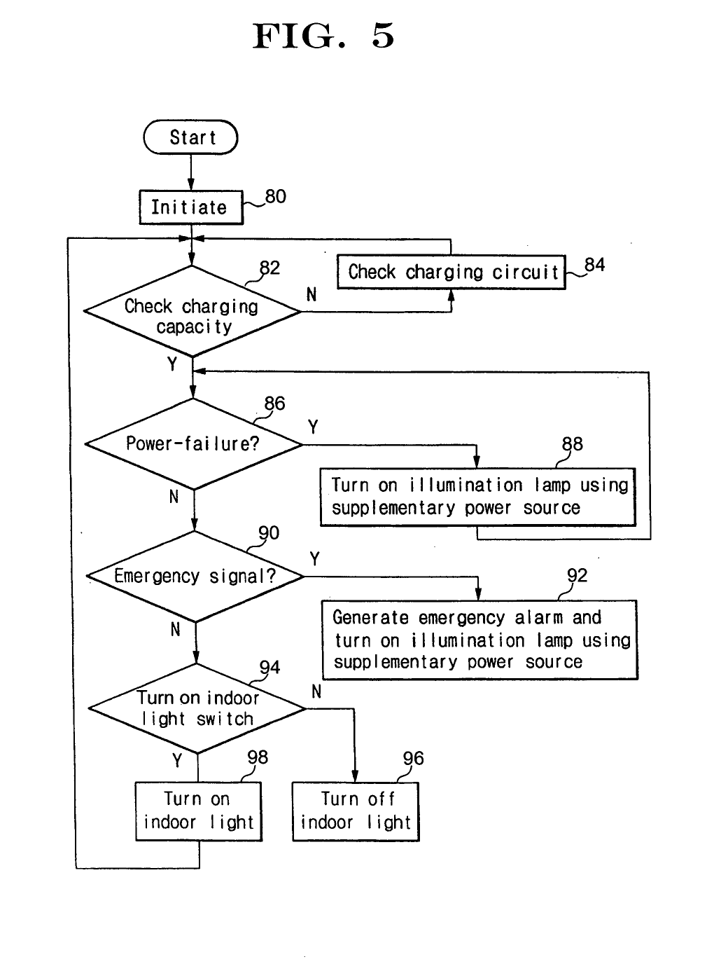

FIG. 4 is a schematic block diagram of a control circuit 40 that may be incorporated into embodiments of the present invention, and FIG. 5 is a flow chart describing the operation of the emergency lighting fixture constructed as switch cover 10. As shown in FIGS. 3 and 4, control circuit 40 includes a power source unit 42 for supplying AC power obtained via leads 43, 44 from a source such as the building electrical service provided by a public utility. Relay unit 45 is controlled by control unit 52 to control distribution of electrical power to each of the units 48, 50, 54, in conformance with control signals received from control unit 52. Charging unit 46 is coupled to power source unit 42, charges a supplementary power source such as one or more dry cells 16 that furnish a supplementary source of electrical power from charging unit 46 to illumination lamp 12. Power-failure unit 48 senses power failures and an emergency sensing unit 50 detects the occurrence of emergency situations like fire or earthquakes. Control unit 52 generates an emergency alarm when charging is complete and when a sensing signal from either sensing unit 48, 50, is received, and also applies a control signal to alarm/illumination operating unit 54 that turns on illumination lamp 12 in response to the control signal from controller 52 by using power supplied from supplementary power source unit 16.

Reference numeral 20 in FIGS. 2, 6 and 7 indicates a wall surface of an architectural structure such as a residential dwelling. An electrical box 22 may be mounted within a recess within wall 20, with its flanges 24 lying flush against the surface of wall 28, to receptively engage the back side of switch cover 10.

When a user pushes illumination lamp switch button 14 disposed on the front surface 32 of the switch cover 10, lamp 12 which is mounted under switch cover 10 is turned on, and the light emitted by illuminated lamp 12 is transmitted through transparent window 13, thereby providing light just below a lower space of switch cover 10. Therefore, the user is able to easily locate switch cover 10 and the array of switch buttons 11, and is then able to easily turn on the indoor lights. In other words, the soft glow from the underside of switch cover 10 enables the user to see things within the indoor area without the necessity of turning on other indoor lights, and thus, can be used as a replacement for bed lights or night table lamps, or in lieu of other supplemental lights.

In the meantime, controller 52 of control circuit 40 checks the charging capacity so that if the charging capacity of the supplemental power source unit 16 is not adequate, controller 52 will operate charging unit 46 to assure that there is a sufficient supplemental power at all times.

Particularly, during power failures, the power-failure sensing unit 48 outputs a power-failure signal to control unit 52. Then control unit 52 triggers the alarm/illumination operating unit 54 and supplementary power source 16 that has been charged through charging unit 46 turns on the illumination lamp 12 to provide illumination through one or more windows 13. On the other hand, during emergency situations, such as fire or earthquakes, emergency sensing unit 50 outputs an emergency signal to control unit 52. Then, the controller initiates the operation of alarm/illumination operating unit 54 to generate an emergency alarm and, at the same time, ensures that emergency lighting provided from illumination lamp 12. Therefore, people in the vicinity of emergency lighting fixture 8 can cope with the sudden loss of primary lighting and with other concurrent emergency situations more effectively and promptly.

Referring now to FIG. 5, in step 80, one exemplary process formed by control circuit 40 is initiated in step 80, and a check of the charged electrical power capacity of power source unit 16 is made. If the capacity is determined to be inadequate, a check is made in step 84, of the operating functionality of charging unit 46; if the charging capacity of power source unit 16 is determined to be acceptable, in step 86 a determination is made whether power failure sensing unit 46 has detected the interruption of electrical power applied via leads 43, 44 and, in response to detection of interruption of electrical power, has applied a corresponding signal to control unit 52. If a corresponding signal generated by sensing unit 48 upon detection of an interruption of electrical power across leads 43, 44 has been received by control unit 52, in step 88 control unit 52 turns on lamp 12 with the power provided by source unit 16; otherwise, the process considers that no interruption of electrical power has occurred, and proceeds to step 90, where a determination is made of whether emergency sensing unit 50 has generated a signal in response to its detection of the occurrence of an emergency such as an earthquake and applied corresponding signal to control unit 52. If sensing unit 50 is found to have applied a signal to control unit 52 that indicates its detection of an emergency, in step 92 control unit 52 initiates generation by operating unit 54 of an emergency alarm and turns on lamp 12, using electrical power from supplemental power source 16.

If in step 90, no emergency signal is found to have been received by control unit 52 from sensing unit 50, a subsequent determination is made in step 94 of whether a user has manually toggled switch 14 to apply electrical energy drawn from leads 43, 44 to illuminate lamp 12. If step 94 determines that the user has in fact toggled switch 14, lamp 12 is illuminated; otherwise, if lamp 12 was already illuminated and switch 14 is toggled, control unit 52 regulates operating unit 54 in step 96, to extinguish the illumination from lamp 12.

As shown in FIG. 7, switch cover 10 can be used like the flashlight after separating switch cover 10 contained by chargeable battery 16 and the illumination lamp 12 from the wall surface 20. In this embodiment, cover plate 10 mounts and encases either one or an array of switch buttons 11 that are operationally exposed through an aperture 30 in the front surface 30 of cover plate 10, and mounts lamp 12 in proximity to adjacent translucent window 13 formed in a lower side wall 33 of cover plate 10. Switch cover 10 is fitted on its reverse side 25 with an electrical connector plug 26 bearing a plurality of electrical conductors (not shown), that is removably received by an electrical socket 27 surface mounted upon printed circuit board PCP 28 mounted within electrical box 22, to enable those electrical conductors to operationally mate with an array of corresponding electrical conductors 29 held by socket 27. Control circuit 40, including supplemental power source 16, may be encased within the interior of cover plate 10. A user may then manually grasp the exterior of cover plate 10 and, with a horizontal pull, withdraw plug 26 from engagement with socket 27; once withdrawn from socket 27, cover plate becomes fully portable, and may serve as a fully charged, hand-held light source. When re-inserted into socket 27, cover plate enables a user to resume operational control of the electrical lighting or other electrically operated appliances connected to switch buttons 11 via plug 26 and socket 27.

Illumination lamp 12 may be installed inside switch cover 10 for protecting the indoor light switch button 11 mounted on the wall surface 20, wherein control circuit 40 fabricated with power source unit 42, charging unit 46, supplementary power source unit 16, power-failure sensing unit 48, emergency sensing unit 50, control unit 52, and the alarm/illumination operating unit 54 ensures that illumination lamp 12 automatically provides lighting during power failures and at the same time, that an emergency alarm is generated by operating unit 54. By turning on illumination lamp 12 in switch cover 10, the user can easily locate the indoor light switch button 11 and the soft glow effect provided from the illumination lamp 12 helps the user to recognize or locate important things indoors, without a need to use bed lights or supplementary lights.

Moreover, the user feels no longer insecure or anxious because he can see most of objects through the lighting provided by the illumination lamp 12 inside the switch cover 10, and is able to react to accidents more promptly when he hears the emergency alarm during emergency situations like fire or earthquakes.

While the invention has been described in conjunction with various embodiments, they are illustrative only. Accordingly, many alternative, modifications and variations will be apparent to persons skilled in the art in light of the foregoing detailed description. The foregoing description is intended to embrace all such alternatives and variations falling with the spirit and broad scope of the appended claims.

1. An emergency lighting fixture in a switch cover, comprising:
at least one of switch buttons on a front surface of a indoor light switch button for turning on/off indoor lights including ceiling lights;
an illumination lamp installed at least one inside surface of the switch cover;
a transparent window installed on the same surface where the illumination lamp is installed, and for transmitting a light from the illumination lamp;
an illumination lamp switch button below the switch buttons to turn on/off the illumination lamp; and
a circuit substrate mounted with a control circuit including a chargeable battery inside the switch cover.

2. The emergency lighting fixture according to claim 1, wherein the control circuit mounted on the circuit substrate comprises:
a power source unit for supplying AC power;
a charging unit coupled to the power source unit and for charging a supplementary power;
a supplementary power source unit for supplying the supplementary power from the charging unit to the illumination lamp;
a power-failure sensing unit for sensing power failures;
an emergency sensing unit for sensing emergency situations like fire or earthquakes;
a control unit for generating an emergency alarm when charging is complete and when a sensing signal from each sensing unit is inputted, and outputting a control signal for turning on the illumination lamp; and
an alarm/illumination operating unit that turns on responding to the control signal from the controller by using power supplied from the supplementary power source unit.

3. A lighting fixture, comprising:
a cover plate having a front surface configured to cover an electrical junction box;
an electrical switch exposed to manipulation through an aperture in said front surface, connectable to respond to said manipulation by influencing application of electrical power to an electrical circuit extending into the junction box;
a lamp encased within said plate;
a translucent window formed in an external surface of said plate, emitting light from said lamp to an environment external to said plate; and
a control circuit encased within said plate, providing a source of electrical power to enable illumination of said lamp upon interruption of the electrical power across the electrical circuit.

4. The fixture of claim 3, with said control circuit comprising:
a battery providing an alternative source of electrical power; and
a battery charging stage connectable to the electrical circuit to provide an electrical charge to said battery.

5. The fixture of claim 3, comprising a second switch exposed by said plate to manual toggling, controlling illumination of said lamp independently of said control circuit.

6. The fixture of claim 3, comprised of:
said control circuit automatically initiating said illumination in response to said interruption; and
a second switch exposed by said plate to manual toggling, enabling and disabling said illumination in response to said toggling, independently of said interruption.

7. The fixture of claim 3, comprised of:
an additional lamp housed within said plate, operationally coupled to provide additional illumination in response to said control circuit; and
a different window formed through said plate to accommodate passage of said additional illumination to the environment external to said plate.

8. The fixture of claim 3, comprised of an electrical connector bearing a plurality of electrical leads, mounted on a reverse side of said plate, disposed to removably mate with corresponding electrical leads within the junction box.

9. The fixture of claim 3, with said control circuit responding to occurrence of an emergency other than said interruption, by providing said illumination of said lamp.

10. The fixture of claim 3, comprised of:
said control circuit automatically initiating said illumination in response to occurrence of an emergency other than said interruption; and
a second switch exposed by said plate to toggling, enabling and disabling said illumination in response to said toggling, independently of said occurrence.

11. The fixture of claim 3, with:
said control circuit comprised of an alarm;
said control circuit automatically initiating activation of said alarm and initiating said illumination in response to occurrence of an emergency other than said interruption.

12. The fixture of claim 3, with:
said control circuit comprised of an alarm;
said control circuit automatically initiating activation of said alarm and initiating said illumination in response to occurrence of an emergency other than said interruption; and
a second switch exposed by said plate to toggling, enabling and disabling said illumination in response to said toggling, independently of said occurrence.

13. The fixture of claim 3, with said control circuit comprising:
a battery providing an alternative source of electrical power;
a battery charging stage connectable to the electrical circuit to provide an electrical charge to said battery, and
a controller monitoring a state of said charge.

14. A process of constructing a lighting fixture, comprising:
providing a cover plate having a front surface configured to cover an electrical junction box;
exposing an electrical switch to manipulation through an aperture in said front surface, with said electrical switch being connectable to respond to said manipulation by influencing application of electrical power to an electrical circuit extending into the junction box;
encasing a lamp within said plate;
forming a translucent window in an external surface of said plate, to emit light from said lamp to an environment external to said plate; and
encasing a control circuit within said plate, to provide a source of electrical power to enable illumination of said lamp upon interruption of the electrical power across the electrical circuit.

15. The process of claim 14, with said control circuit comprising:
a battery providing an alternative source of electrical power; and
a battery charging stage connectable to the electrical circuit to provide an electrical charge to said battery.

16. The process of claim 14, comprised of exposing a second switch through said plate to manual toggling controlling illumination of said lamp independently of said control circuit.

17. The process of claim 14, comprised of:
said control circuit automatically initiating said illumination in response to said interruption; and
exposing a second switch through said plate to manual toggling enabling and disabling said illumination in response to said toggling, independently of said interruption.

18. The process of claim 14, comprised of mounting on a reverse side of said plate an electrical connector bearing a plurality of electrical leads disposed to removably mate with corresponding electrical leads within the junction box.

19. The process of claim 14, with said control circuit responding to occurrence of an emergency other than said interruption, by providing said illumination of said lamp.

20. The process of claim 14, comprised of:
said control circuit automatically initiating said illumination in response to occurrence of an emergency other than said interruption; and
exposing a second switch through said plate to manual toggling enabling and disabling said illumination in response to said toggling, independently of said occurrence.
